(19) United States
(12) Patent Application Publication
(10) Pub. No.: US 2026/0235457 A1
(43) Pub. Date: Aug. 13, 2026

(54) Inductive Impact Sensing Device

(71) Applicant: 1625986 Ontario Limited, Mt Brydges (CA)

(72) Inventors: Geoff Taylor, Treasure Isalnd, FL (US); Vitaliy Degtyaryov, Oakbank (CA)

(21) Appl. No.: 19/153,760

(22) PCT Filed: Oct. 20, 2023
(86) PCT No.: PCT/IB2023/060593

§ 371 Date: Aug. 5, 2025

Related U.S. Application Data
(60) Provisional application No. 63/417,927, filed on Oct. 20, 2022.

(51) Int. Cl. G01L 1/12

(52) U.S. Cl. CPC G01L 1/127

(57) ABSTRACT

Embodiments provide a force sensing apparatus comprising: (a) a sheet have first and second opposing surfaces, comprising a material have a compressibility normal to the surfaces of the sheet and a stretchability parallel to the surfaces of the sheet; (b) one or more first conductive elements mounted with the first surface of the sheet; (c) one or more second conductive elements mounted with the second surface of the sheet, where the first and second conductive elements are configured such that current does not directly flow between them, and such that an alternating signal supplied to a first conductive element inductively couples to a second conductive element and produces a responsive alternating signal.

### TECHNICAL FIELD

The present invention relates to the field of systems that sense forces applied over time, including impact or shock forces, and more particularly to sensors comprising inductively coupled conductors.

### BACKGROUND

It is often desirable to know the impact or shock applied over a short period of time. This can be viewed as measuring the amount of crush or stretch and the sideways movement over the time of the impact. Pressure-sensitive mats have been proposed for such applications, but current configurations using resistive sensors or capacitive sensors are typically limited to lighter compressive loads and require longer read times.

There is a need for methods and apparatuses that can detect not only the amplitude of the normal component of the applied forces but also detect the sideways component, and give a true vector in space of the applied forces and be able to do this over a short period of time.

### SUMMARY OF THE INVENTION

Embodiments of the present invention comprise a piece of fabric modified in such a way to allow it to measure the severity and direction of the impact. The device can be placed in a suitable location to measure the impact or the crush and twist, of situations like, quantifying head strike in a protective helmet or a foot strike and toe off on the ground or carpet. It can also be used to measure the impact of a golf club on a golf ball, or the impact of a hockey puck or a baseball on a glove. The device can also be used to discover the crush and changes of crush over longer periods of time.

Embodiments of the invention provide a force sensing apparatus comprising: (a) a sheet have first and second opposing surfaces, comprising a material have a compressibility normal to the surfaces of the sheet and a stretchability parallel to the surfaces of the sheet; (b) one or more first conductive elements mounted with the first surface of the sheet; (c) one or more second conductive elements mounted with the second surface of the sheet, where the first and second conductive elements are configured such that current does not directly flow between them, and such that an alternating signal supplied to a first conductive element inductively couples to a second conductive element and produces a responsive alternating signal.

In some embodiments, the first conductive elements comprise an electrical conductor disposed in a first loop parallel to the first surface, and the second conductive elements comprise an electrical conductor disposed in a second loop parallel to the second surface, wherein each second conductive element is disposed such that the area of the second loop of the second conductive element overlaps the area of the first loop of a corresponding first conductive element.

In some embodiments, the first loop has a circular shape. In some embodiments, the second loop has a circular shape. Some embodiments further comprise a signal generator configured to supply an excitation signal to the first conductive elements. In some embodiments, the excitation signal is a time varying signal, with a lowest frequency component from 10 Hz to 100 kHz. In some embodiments, the excitation signal is a time varying signal, with a lowest frequency component from 100 Hz to 20 kHz. In some embodiments, the excitation signal is a time varying signal, with a lowest frequency component from 1kHz to 10 kHz. In some embodiments, the excitation signal has a voltage that varies from peak to trough by 0.1V to 25V. In some embodiments, the excitation signal has a voltage that varies from peak to trough by 4V to 6V. In some embodiments, the excitation signal is sinusoidal.

Some embodiments further comprise a detector configured to detect the responsive alternating signal from the second conductive elements. Some embodiments further comprise an analysis system configured to compare the amplitude of the responsive alternative signal to the excitation signal and determine a force acting on the sheet from the magnitude comparison. Some embodiments further comprise an analysis system configured to compare the phase of the responsive alternative signal to the excitation signal and determine a force acting on the sheet from the phase comparison. In some embodiments, the analysis system is further configured to compare the phase of the responsive alternative signal to the excitation signal and determine a force acting on the sheet from the phase comparison, and to determine a component of force normal to the first surface of sheet from the magnitude comparison, and to determine a component of force parallel to the first surface of the sheet from the phase comparison. In some embodiments, wherein the sheet comprises a fabric, and wherein the first conductive elements comprise a conductive thread sewn into sheet.

Some embodiments provide method of determining force acting on a sheet, comprising supplying an apparatus as described herein, supplying an excitation signal to the first conductive elements, sensing the responsive signal from the second conductive elements, comparing the magnitudes of the excitation signal and the responsive signal, comparing the phases of the excitation signal and the responsive signal, and determining the forces from the comparisons of magnitude and phase.

### DESCRIPTION OF THE DRAWINGS

FIG. 1 is a schematic drawing of an example conductive loop for use in the present invention.

FIG. 2 is a schematic drawing of an example conductive loop for use in the present invention.

FIG. 3 is a schematic drawing of example conductive loops for use in the present invention.

FIG. 4 is a schematic drawing of an example embodiment of the present invention.

FIG. 5 is a schematic drawing of an example embodiment of the present invention.

FIG. 6 is a schematic illustration of an example embodiment as in FIG. 5, before and after being acted on by a force normal to the surfaces.

FIG. 7 is a schematic illustration of an example embodiment like that in FIG. 5 before and after being acted on by a force parallel to the surfaces.

FIG. 8 is a schematic illustration of a top view an example grid embodiment.

FIG. 9 is a schematic diagram of an example embodiment.

FIG. 10 is a schematic illustration of an example embodiment. The responsive signal is a corresponding sinusoid, with a magnitude represented by the arrow to the left.

FIG. 11 is a schematic illustration of the example embodiment of FIG. 10 after application of a force normal to the surface of the sheet.

FIG. 12 is a schematic illustration of the example embodiment of FIG. 10 after application of a force parallel to the surface of the sheet

FIG. 13 is a schematic illustration of an example embodiment.

FIG. 14 is a schematic illustration of an example embodiment.

FIG. 15 is a schematic illustration of an example embodiment.

### DESCRIPTION OF INVENTION

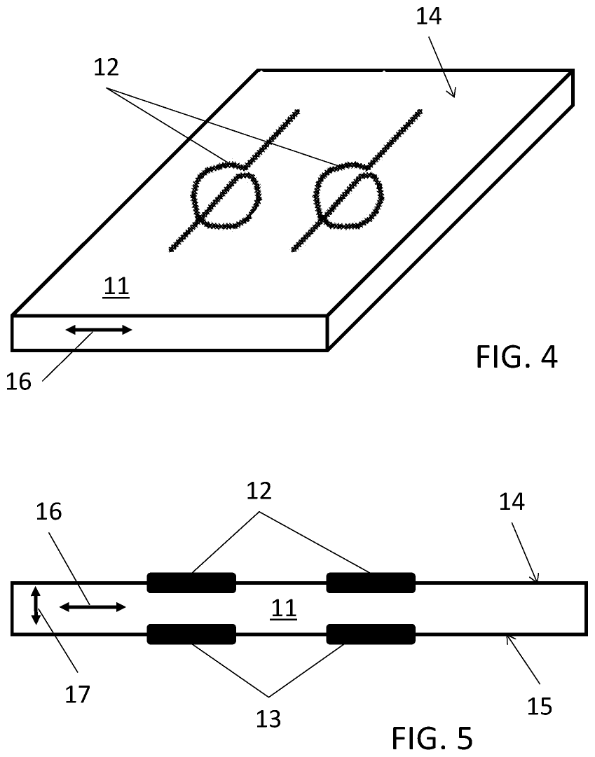

FIG. 5 is a schematic illustration of a section through an example embodiment of the present invention. FIG. 4 is a perspective view of the example embodiment shown in section in FIG. 5. A compliant material forms a sheet 11. The material is deformable in at least one aspect. As examples, the material can be stretched or compressed in the plane 16 of the sheet parallel to the large surfaces 14, 15 of the sheet; bent such that the large surfaces or faces 14, 15 of the sheet are non-planar; stretched or compressed orthogonal 17 to the surfaces of the sheet, or combinations thereof. A stretchy fabric such as Lycra is an example of a suitable material. Any compressible and stretchable material can be suitable, e.g., silicone rubber, nitrile rubber, neoprene rubber. In some embodiments, the material can be selected so that the thickness of the material and its resistance to compression cooperate such that the maximum anticipated normal force compresses the material almost fully, but not to the point where the conductive elements on opposing faces (described below) touch. In some embodiments, the material can be selected such that the material's stretchability (relative motion of the two opposing surfaces) accommodates the range of anticipated forces normal to the surfaces, allowing stretching of the material without damaging it over the range of anticipated forces.

Conductive elements 12, 13 are mounted with opposing surfaces 14, 15 of the sheet 11. Conductive elements 12, 13 can be mounted on the surface, embedded completely in the surface, or mounted partially embedded and partly protruding above the surface (as depicted in the figure). Two conductive elements are shown on each of the opposing surfaces; embodiments of the invention can use a single element on one surface, or any number of conductive elements on one or both opposing surfaces. The invention is described herein in the context of a roughly planar structure for ease of illustration. The structure can be configured to form a curved surface, where the conductive elements detect forces normal and orthogonal to the plane of the curved surface at the location of the conductive elements. Similar conductive elements can be deployed on a three dimensional shape, where placement of the conductive elements and the shape of the three dimensional shape determine the coordinate system for forces detected.

Conductive elements are disposed with the sheet such that they have mutual inductance (such elements are referred to herein both as conductive elements and as inductive elements).

Electrical signals are accordingly transferred between the conductive elements. The shapes, materials, and relative positions of the conductive elements provide a mutual inductance that influences signal transference between them. Compression or elongation of the sheet, and bending of the sheet, changes the shape, relative positions, or both, of the conductive elements, and accordingly changes the mutual inductance. The change in mutual inductance is related to the change in shape and position. Knowledge of the mechanical properties of the material allows the change in mutual inductance to be used to determine the forces that acted upon the sheet to cause the change in shape or position of the conductive elements.

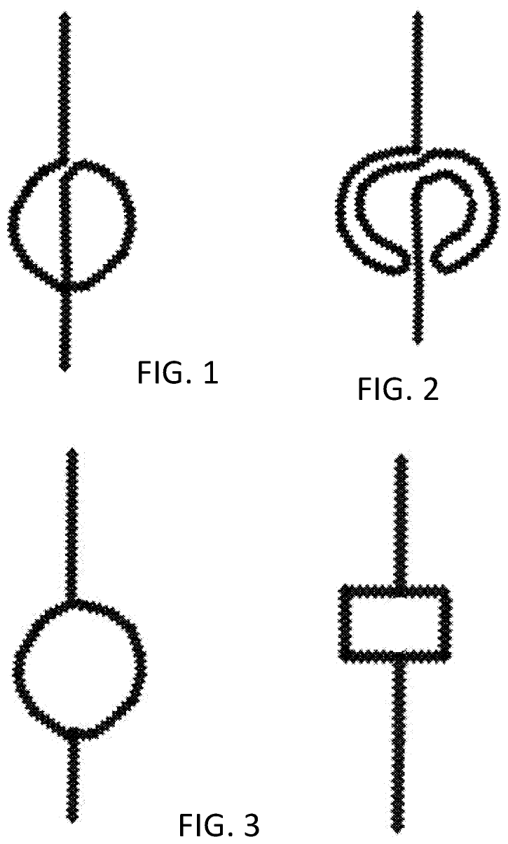

In one embodiment of the invention the conductors are sewn onto both surfaces of a relatively thick and stretchy fabric using uncoated wire or commercially available conductive threads such as silver coated threads or electrically conductive polymer coated threads. The conductor threads are sewn into the thick stretchy fabric using a mating nonconductive back stitch thread, and the tensions of the sewing machine are adjusted such that the conductive portion of the stitch rides on the outer surface of the fabric. A zig zag stitch can be used to retain the stretchability of the fabric and to increase the signal strength by increasing the effective width of the trace. At the sensing location the stitches are made to form a shape such as a circular loop such that the loops are on either side of the fabric and are aligned and co located, separated only by the intervening insulating fabric. Example shapes are shown in FIGS. 1, 2, and 3. FIG. 3 shows two variations of a closed loop: one with a rounded loop, one with a rectangular loop. Other shapes can also be suitable. Design of the shape of the conductive elements can be informed by fabrication techniques (e.g., some shapes are convenient to sew, some shapes are convenient for printing, some shapes are convenient for other deposition methods), and by the mutual inductance desired. The size of the conductive elements, e.g., the diameter of the loops in the examples in the figures, can also be informed by the fabrication techniques and desired mutual inductance, as well as by the dimensions of the sheet (e.g., the thickness of the sheet defines the separation between the conductive elements on opposing faces of the sheet).

The sensor can be interrogated by putting a voltage as small as (0.1V to 25V, e.g. 4-6V) time-varying signal (e.g., a sinusoidal alternating signal voltage of a frequency ranging from 10 Hz to 100 kHz, or from 100 Hz to 20 kHz, or from 1 kHz to 10 kHz) onto one conductive thread and the voltage induced on the adjacent thread is measured. The collocated conductive elements (e.g., loops) serve to make the primary influence of the difference come from the relative location of the conductive elements. Compression (e.g., by a force acting toward the sheet such as a weight pressing down) or expansion (e.g., by a force acting away from the sheet such as removal of a weight pressing down, or aerodynamic negative pressure over an airfoil) of the sheet changes the distance between conductive elements on opposing surfaces; the distance between the elements affects the mutual inductance, and thus compression or expansion of the material changes the magnitude of the signal induced in a conductive element on one face of the sheet by the excitation signal applied to the corresponding conductive element on the opposing face of the sheet. Many of the examples presented herein assume a force compressing the sheet; forces that expand the thickness of the sheet are also contemplated in the present invention. Stretching of the sheet, or the displacement of one surface relative to the opposing surface in the direction of the surfaces, causes the conductive elements to displace relative to each other (e.g., corresponding loops will no longer be centered relative to each other), which causes the phase of the signal induced in a conductive element on one face of the sheet to change relative to the phase of the excitation signal applied to the corresponding conductive element on the opposing face of the sheet.

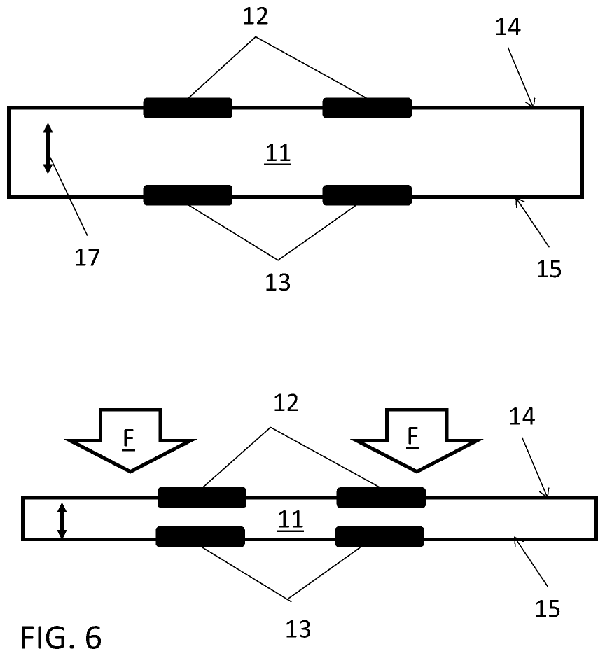

FIG. 6 is a schematic illustration of an example embodiment as in FIG. 5, before and after being subjected to a force F normal 17 to the surfaces 14, 15 of the sheet 11. In the top figure, the conductive elements 12, 13 are separated by a first distance corresponding with the thickness of the sheet. The force Facts to compress the sheet 11, as shown in the bottom portion of the figure. Conductive elements 12, 13 are now separated by a second distance, lesser than the first distance, corresponding to the thickness of the compressed sheet 11. The mutual inductance of the conductive elements 12, 13 is dependent in part on the separation between them, thus the change in mutual inductance corresponding to the magnitude of the signal can be used to determine the compression of the sheet. The compression of the sheet is dependent on the properties of the sheet and the magnitude of the force, thus the magnitude of the force can be determined from the change in mutual inductance and the known material properties of the sheet. If the mutual inductance is monitored continuously, near-continuously, or at sufficient small intervals, then the timing of the applied force can also be determined from the time-dependence of the changes in mutual inductance.

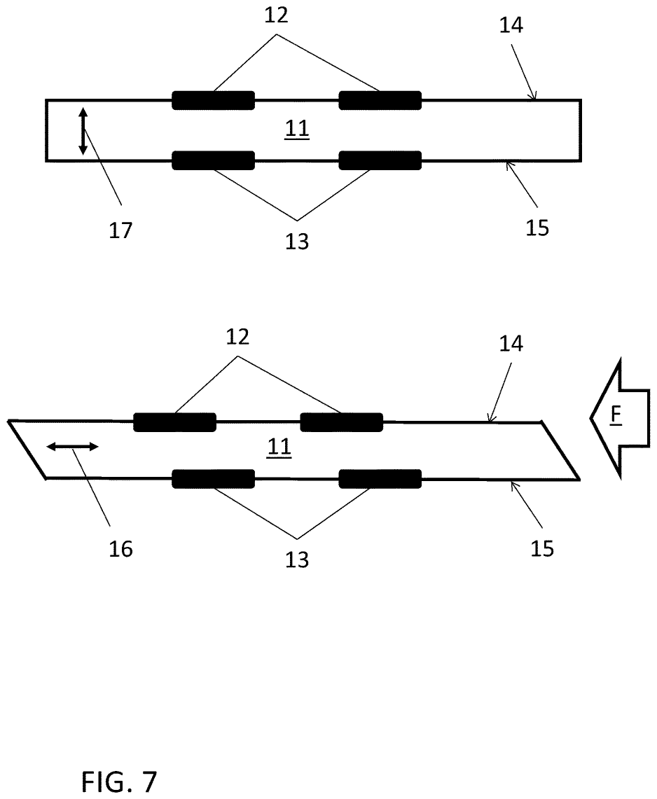

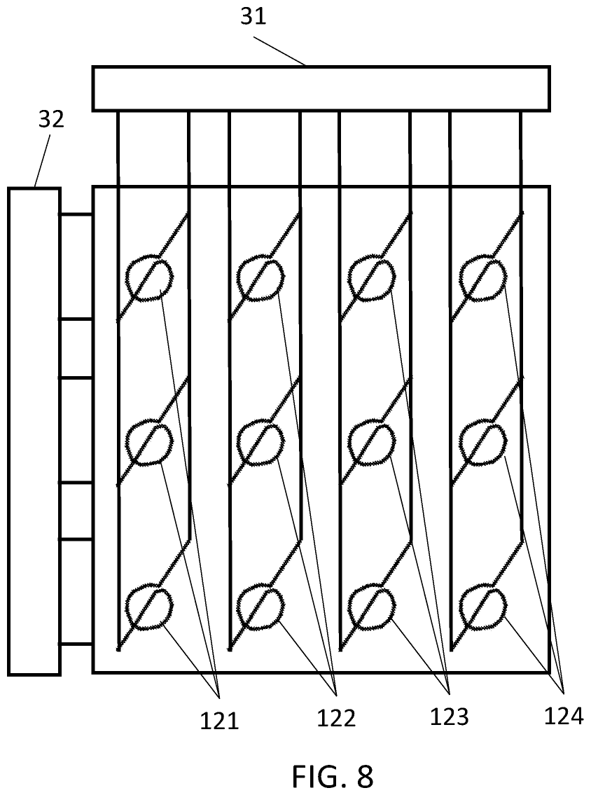

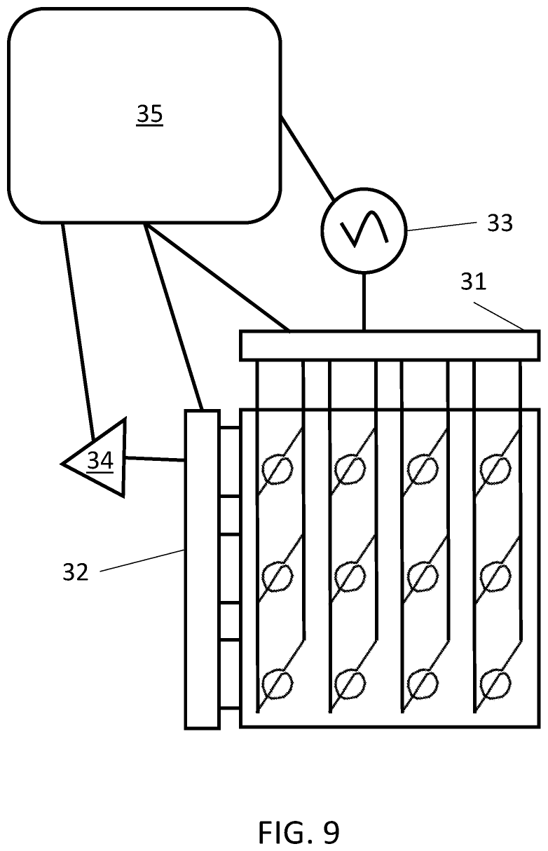

The phase of the induced voltage on the receiving loop circuit is directly related to the spatial displacement of the two loops. This is because the two loops are spatially displaced when a sideways force is also present. FIG. 7 is a schematic illustration of an example embodiment like that in FIG. 5 before and after being acted on by a force F parallel to the surfaces 14, 15 of the sheet 11. The top portion of the figure shows the embodiment prior to application of the force F. In the lower portion of the figure, a force F has shifted the top surface 14 relative to the bottom surface 15. The conductive elements 12 are accordingly shifted relative to the conductive elements 13. Since the mutual inductance is determined in part by the overlap of the conductive elements, the phase of signal corresponding to the mutual inductance can be used to determine the displacement of conductive elements 12 relative to conductive elements 13. The displacement of the elements on the sheet is dependent on the properties of the sheet and the magnitude of the force, thus the magnitude of the force can be determined from the change in mutual inductance and the known material properties of the sheet. If the mutual inductance is monitored continuously, near-continuously, or at sufficient small intervals, then the timing of the applied force can also be determined from the time-dependence of the changes in mutual inductance.

Two orthogonal components of the applied force can thereby be determined. The strength and phase angle of the voltage induced by mutual inductance forms the basis for determining the vector direction of the applied force and resulting deformation of the sheet. The time over which the force takes place is measured by noting the time from the first onset of inductance change, to time at which the inductance no longer changes.

Conductive elements can be disposed at multiple locations on a sheet, e.g., in a grid, to allow contemporary sensing of forces applied at many locations in the sheet. In an array of sensors, the collocated loops can be sized and positioned on the sheet at a desired spatial resolution. In an array, the rows and columns can be interrogated with the sinusoidal AC voltage individually and the measurements can be combined to give an overall image of the individual fabric crush deformation vectors. FIG. 8 is a schematic illustration of a top view an example grid embodiment. Conductive elements 121, 122, 123, 124 are disposed in an array, having three rows of four columns, on the top surface of a sheet. Corresponding conductive elements, not visible in the figure, are disposed in a corresponding array on the bottom surface of the sheet, where “corresponding” includes any disposition where the mutual inductance between conductive elements on the top and bottom surfaces of the sheets is known or can be determined, and is correlated with deformation of the sheet responsive to applied forces. In operation, an excitation signal (e.g., a sinusoidally varying voltage) can be applied to each column in the array by a multiplexer 31. E.g., the voltage can be applied to conductive elements 121 during a first time period T1, to conductive elements 122 during a second time period T2, to conductive elements 123 during a third time period T3, and to conductive elements 124 during a fourth time period T4. During each of T1, T2, T3, and T4, conductive elements on the bottom surface can sampled using a multiplexer 32. E.g., during T1, multiplexer 32 can be configured to sample the top row element during time T1-1 (a first subset of time T1), then to sample the second row element during time T1-2 (a second subset of time T1), then the third row element during time T1-3 (a third subset of time T1). This sequence can be repeated during each of T1, T2, T3, and T4. As an example, an array of 32 by 32 sensors can be configured to cover an area the size of a seat cushion to show the ischial tuberosities and other pressure points of a seated individual. An array of 64 by 64 sensors can be configured to detect magnitude, location, and timing of the forces of tire treads as a car drives over the array.

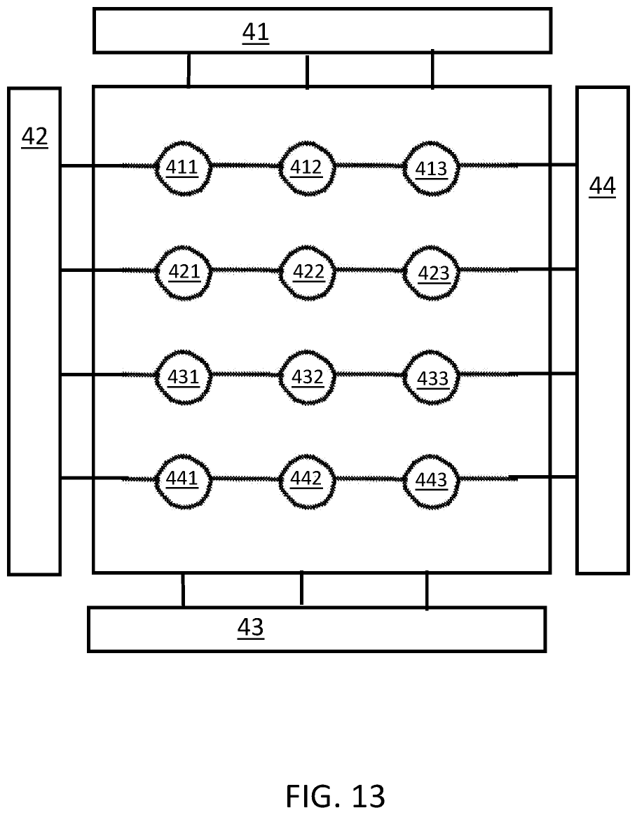

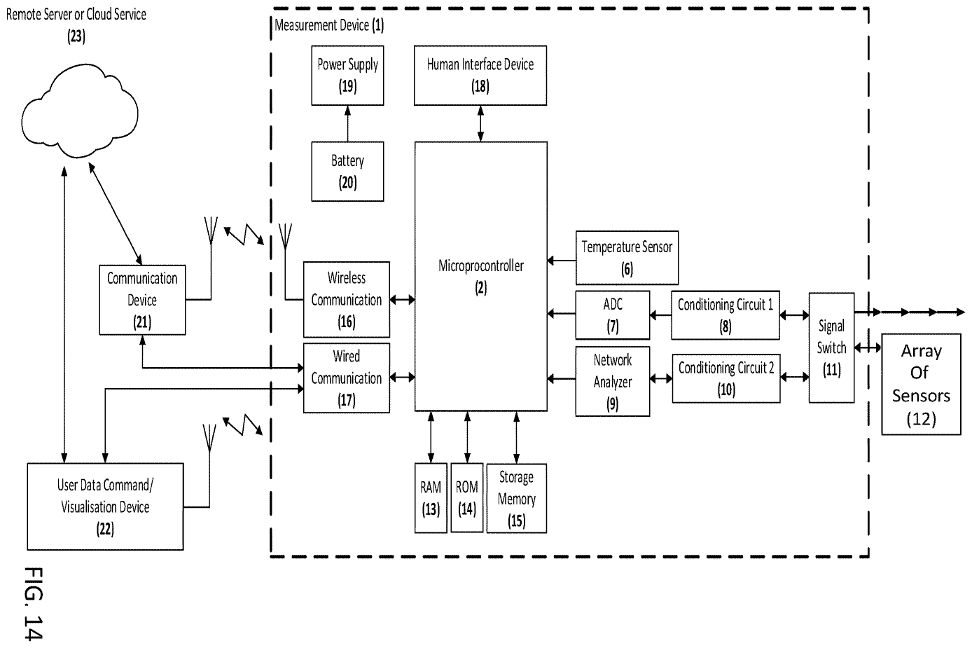

FIG. 13 is a schematic illustration of an example embodiment. Conductive elements are depicted as loops in the figure. Loops on one surface of a sheet are shown; corresponding loops are on the opposite surface of the sheet. The loops on each side are arranged in rows: loops 411, 412, 413 form a first row; loops 421, 422, 423 form a second row; loops 431, 432, 433 form a third row; and loops 441, 442, 443 form a fourth row. The loops are also arranged on columns: loops 411, 421, 431, 441 form a first column; loops 412, 422, 432, 442 form a second column; loops 413, 423, 433, 443 for a third column. Corresponding loops for corresponding rows and columns on the opposite side of the sheet. Multiplexers 42, 44 apply an excitation signal across individually selectable rows of loops on the side of the sheet visible in the figure. Current in the loops on the selected row induces a responsive current in the corresponding loops on the opposite side of the sheet. Multiplexers 41, 43 select individually selectable columns for sampling the responsive signal. As an example, multiplexers 42, 44 can be configured to apply an excitation signal to the second row. Multiplexers 41, 43 can be configured to select the third column for sampling, resulting in the sampled signal representing the mutual inductance between the loops in the second row on the visible side of the sheet and the loops in the third column of the opposite side of the sheet, which will be dominated by the mutual inductance between loop 423 and the corresponding loop on the opposite side of the sheet. This allows the forces at individual locations in the sheet to be determined. The multiplexers can select individual rows and columns at a high rate, e.g., if the excitation signal is at 10 kHz, the multiplexers can select rows and columns at 2 kHz and still allow 5 cycles of signal to be sampled and analyzed at each loop location. If the sheet has 100 loops on each surface, a complete map of forces on the sheet can be obtained at a rate of 20 Hz. The complete force map can thus be updated 20 times per second. The excitation signal and multiplexer rates can be adjusted to accommodate differing numbers of loops and different desired update rates.

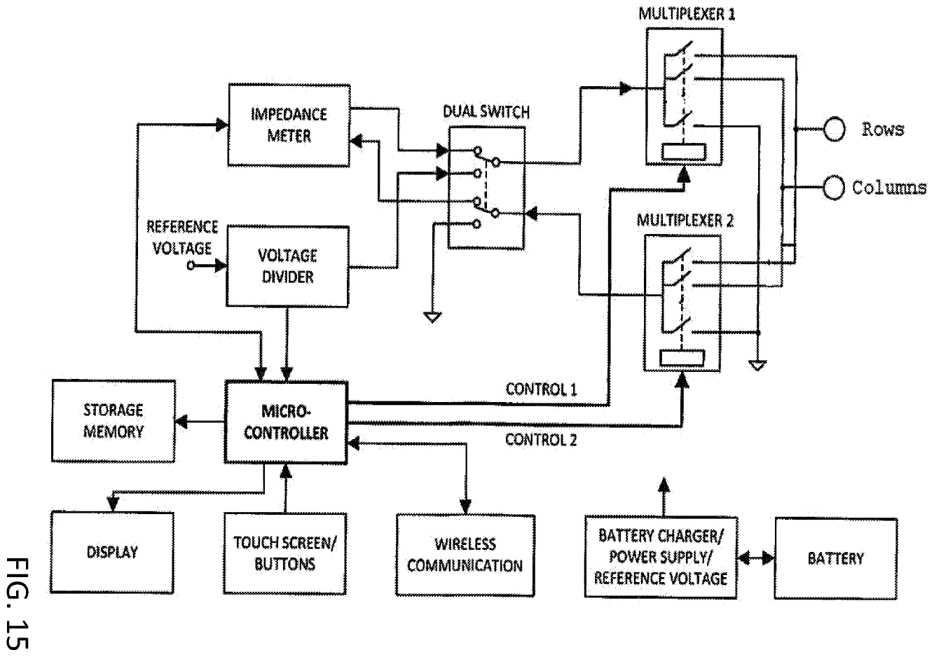

FIG. 9 is a schematic diagram of an example embodiment. A sheet with conductive elements, like those described elsewhere herein, is connected through a multiplexer 31 to an oscillator 33. The sheet is also connected through a second multiplexer 32 to a sensor 34. The multiplexers are controlled by a controller 35, which also controls the oscillator 33 and receives input from the sensor 34. The controller can comprise special purpose analog or digital circuitry, or can be implemented in software in a microcontroller. Impedance measurements such as those contemplated in example embodiments can be performed with circuitry such as that described in “An analog front-end enables electrical impedance spectroscopy system on-chip for biomedical applications,” Fernando Seoane, Javier Ferreira, Juan Jose Sanchez, Ramon Bragos, Physiol. Meas. 29(2008 ) S267-S278, which is incorporated herein by reference. The controller can also be configured to analyze the excitation signals, sensor input, and timing to determine forces acting on the sheet, as described elsewhere herein. FIGS. 14 and 15 are schematic illustrations of control circuitry and analysis and communication systems that can be suitable for use with various configurations of sheets and conductive elements.

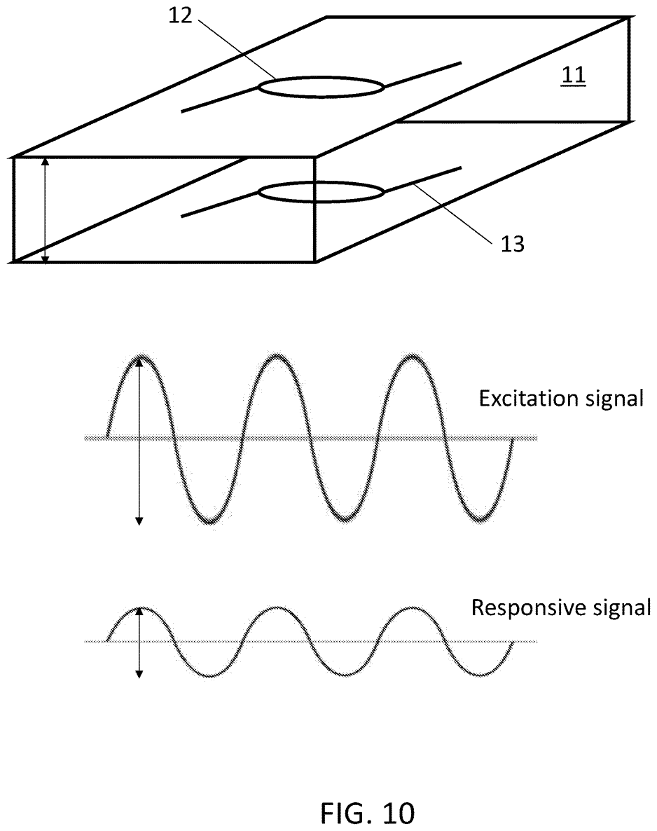

FIG. 10 is a schematic illustration of an example embodiment. The example embodiment is simplified for ease of illustration. A sheet 11 has first 12 and second conductive elements disposed on or in its opposing surfaces. The surfaces are at a first distance apart, represented by the arrow at the left. An excitation signal, in the illustration a sinusoid, is applied to the first conductive element. The excitation signal has a magnitude, represented by the arrow at the left. A responsive signal is produced in the second conductive element due to the mutual inductance of the first and second conductive elements. The responsive signal is a corresponding sinusoid, with a magnitude represented by the arrow to the left.

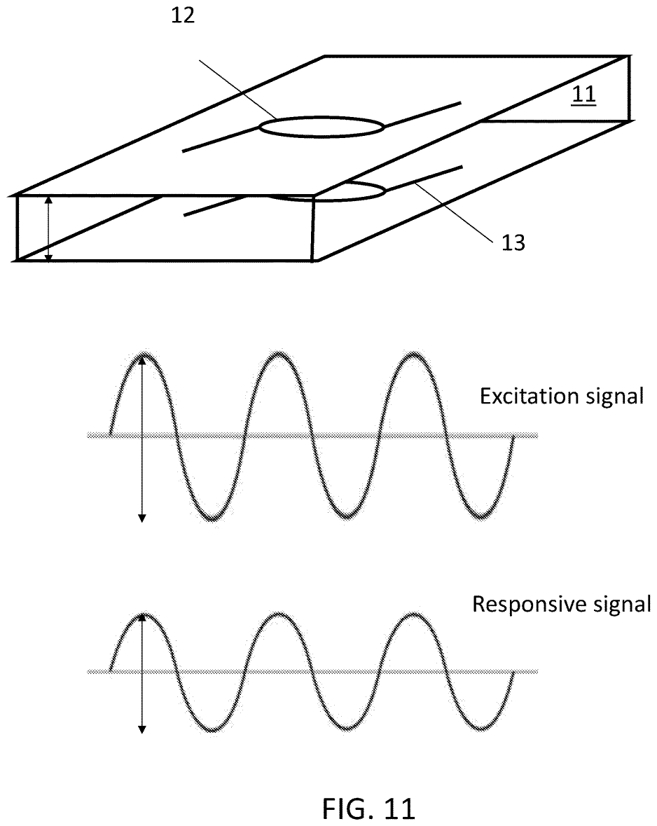

FIG. 11 is a schematic illustration of the example embodiment of FIG. 10 after application of a force normal to the surface of the sheet. The sheet 11 has been compressed responsive to the force, bringing first 12 and second 13 conductive elements closer together. The decreased separation increases their mutual inductance, and accordingly the responsive signal has a greater magnitude than that in FIG. 9. The change in magnitude, or the change in the difference between excitation signal magnitude and responsive signal magnitude, is a function of the separation of the surfaces, and thus representative of the force applied normal to the surfaces of the sheet 11.

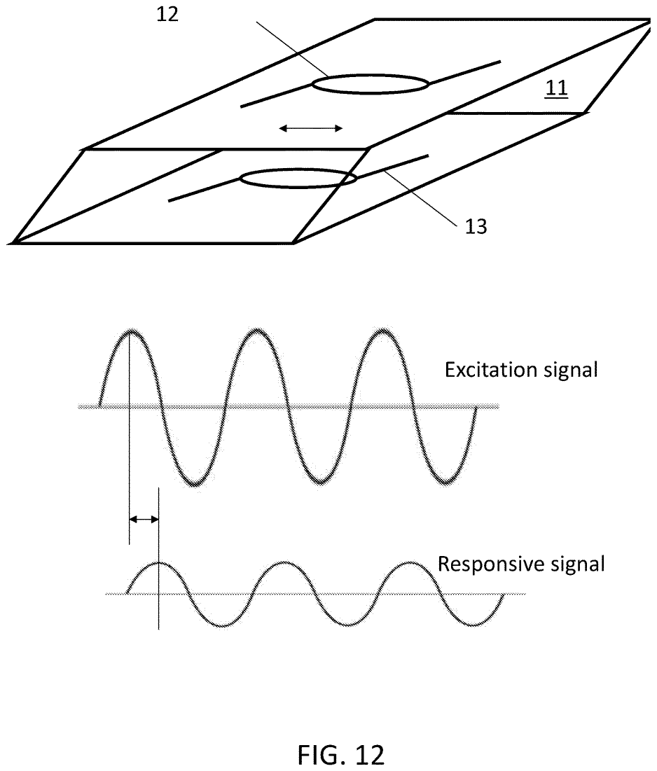

FIG. 12 is a schematic illustration of the example embodiment of FIG. 10 after application of a force parallel to the surface of the sheet. The surfaces of the sheet 11 have been displaced relative to each other responsive to the force, changing the overlap of first 12 and second 13 conductive elements. The changed overlap changes the mutual inductance and causes a phase shift between the excitation signal and the responsive signal. The change in phase is a function of the displacement of the surfaces, and thus representative of the force applied parallel to the surfaces of the sheet 11.

Note that in FIGS. 11 and 12 the excitation signal and responsive signal are depicted in idealized, simplified representations. The excitation signal can comprise various other waveforms. The responsive signal will depend on the various electrical response characteristics of the conductive elements and the mutual inductance, and can comprise a response at the fundamental frequency of the excitation signal combined with higher frequency components. E.g., each arc of a loop can be offset by slightly different amounts, which can lead to amplitude changes as well as phase shifts.

### EXAMPLE APPLICATIONS

### Since this Method of Sensing Forces can be made to Function at Low Frequencies and Low Voltages it is Safe for use on People, Including People whose Medical Condition is already Compromised

Medical Bed. An example embodiment can comprise a sheet sized to cover a bed, with inductive elements disposed with the sheet to indicate sacral forces on the patient as the patient is tilted and reclined.

Smart Bed. An example embodiment can comprise a sheet sized to cover a bed, with inductive elements disposed with the sheet to indicate contact forces and shear forces on the patient, optionally including actuators responsive to the determined forces that control the shape of the bed to minimize forces or to encourage or discourage movement of a person on the bed.

Stretcher, backboard, retention strap pressures. An example embodiment can comprise a sheet sized to fit a stretcher, backboard, or similar patient support and restraint device; with-inductive elements disposed with the sheet to determine and track the intensity and duration of forces on a patient on the device. Immobilization on such devices can result in pressure ulcers; tracking force magnitude and duration can alert responders to necessary adjustments, and can help guide subsequent treatment.

Nursing home and seniors. An example embodiment can comprise a sheet sized to cover a bed, with-inductive elements disposed with the sheet to indicate contact forces and shear forces on a person in the bed, to indicate forces on the person and provide alerts as to problems reflected in such forces.

Patient monitoring. An example embodiment can comprise a sheet sized to cover a bed, with inductive elements disposed with the sheet to indicate contact forces and shear forces on a person in the bed. The magnitude and timing of the forces can be related to respiration, pulse, blood pressure, snoring, sleep apnea, and other conditions that can be useful to a caregiver. Other sensors, e.g., body temperature, can be included in the embodiment to provide an integrated patient monitoring system.

Shoe fitting and performance. An example embodiment can comprise a sheet sized to integrate with a shoe or prosthetic, with inductive elements disposed with the sheet to indicate contact forces and shear forces on a foot or limb in contact with the shoe or prosthetic. The forces can assist in proper initial fitment, subsequent adjustments, indicated modifications, and wear/replacement functions.

Rehabilitation and recovery. An example embodiment can comprise a sheet configured top mount with a floor mat, a treadmill, stairs, a ramp, or other such surface. Mutual inductance of conductive elements can allow determination of forces from a subject walking or standing on the surface, with the forces providing feedback concerning the subject's balance (e.g., in recovery from a stroke), strength, speed, or other characteristic.

Wheelchair, Senior Electric scooters. An example embodiment can comprise a sheet configured to mount with a seat cushion on a wheelchair, scooter, or similar device. Mutual inductance of conductive elements mounted with the sheet can indicate forces exerted on or by a person seated on the device, and can be used as feedback for control of the device, as indications of proper and safe use, and as predictors of sores or other maladies arising from improper forces.

Blood pressure. An example embodiment can comprise a sheet configured to wrap around a limb of a subject. Mutual inductance of conductive elements can provide indication of forces form the limb, allowing continuous blood pressure measurements. The timing of the forces determined can allow detection of heart beats, which can be used in conjunction with the determined forces to provide information concerning cardiovascular performance of the subject.

Flooring. An example embodiment can comprise a sheet sized to cover a region of a the floor of a building, directly exposed to foot traffic or underlaying carpet or another floor covering. Mutual inductance of conductive elements mounted with the sheet can detect magnitude and direction of forces resulting from a person walking over that region. The forces can be used analyze walking or running gaits for diagnostic or training purposes, and can be used to match with known gait characteristics as a biometric security system. The forces can also be used to determine characteristics of a person's travel, e.g., for sales by detecting when a person spends more time interacting or observing a particular item or region of a store, e.g., for controlling alarm systems be detecting when an authorized person travels in a pattern matching an alarm arming condition (e.g., when a security guard is making rounds, disabling alarms immediately surrounding the guard and re-arming them as the guard passes).

Muscle contraction meter. An example embodiment can comprise a sheet configured as a band that can be wrapped around or taped to a subject; e.g., a waist band or arm band, or a strip that can be adhered to a portion of a leg or torso. Mutual inductance of conductive elements mounted with the sheet can determine forces exerted by the region of the subject; e.g., timing and magnitude of muscle contractions during delivery of a baby, muscle tension in response to exercise or stress, etc.

Telekinetics. An example embodiment can comprise a sheet with inductive elements as described herein, configured to detect forces such as a glove for detecting forces relative to a subject's hand, or a boot to detect forces relative to a subject's foot. The forces can then be transmitted to an actuator device, e.g., a pad with multiple inflatable portions, to allow the forces applied to the sheet to be reflected at the actuator device, e.g., to be felt by a second subject interacting with the actuator device.

Tooth bite mapping. An example embodiment can comprise a sheet with inductive elements as described herein, configured to interface between teeth of a patient and a reference or the opposing teeth. The embodiment can determine forces from biting, to assist in designing appliances or in correcting bite characteristics of the patient.

Keyboard and input device. An example embodiment can comprise a structure having holes, projections, or indentations that can be engaged by the hands or fingers of a user. One more sheets with inductive elements can be mounted with the structure; e.g., wrapped around projections, or mounted with the sides or bottom of a hole; to sense forces applied by the hand or finger. Inputs, e.g., mouse clicks or selection of individual keys on a keyboard, can be activated responsive for forces, or changes in forces (including changes in magnitude and changes in direction) applied by the user.

Inputs can thus be activated without requiring motion from the user, and with force requirements tailored to specific needs of the user. This can be advantageous for users suffering from disorders such as carpal tunnel syndrome and users recovering from injuries. This can also be used for more compact encoding of inputs; e.g., an upper case latter can be selected by applying a force downwards and also away from the user, and a lower case letter selected by applying a force downwards and also toward the user.

Wrist rest. An example embodiment can comprise a sheet with-inductive elements as described herein, configured to form a wrist rest, or to mount over or under a separate wrist rest. The embodiment can determine forces exerted by the wrist when resting on the rest to help determine proper user technique, e.g., in typing, and to inform modifications of the wrist rest to better accommodate the user's actual use characteristics.

Straps. An example embodiment can comprise a sheet with inductive elements as described herein, mounted with, or forming part of, lift straps or harnesses. The forces determined by the embodiment can monitor for excessive loading on the straps or harness. The embodiment can also be arranged such that it is under the portions of the item (e.g., a sensitive object or a person) engaged by the straps. The forces determined can be used to monitor for appropriate forces on the item (e.g., low enough to avoid damage to an object, or to avoid injury to the person), and can also readily indicate improper placement of the straps if the forces determined do not match an expected force profile (any of magnitude, direction, and timing).

Compression bandage. An example embodiment can comprise a sheet with inductive elements as described herein, forming part of a bandage, or configured to work with a bandage such as a strip placed between the bandage and a patient (human or animal). The forces sensed can be used to inform the application of the bandage to facilitate desired pressure from the bandage on the patient, and can provide confirmation that the bandage is properly installed and that the bandage continues to exert proper pressure after passage of time or occurrence of disruptive events.

Scoliosis brace. An example embodiment can comprise a sheet with inductive elements as described herein, configured as a vest-like structure configured to sense forces applied to a patient's rib cage or spine, e.g., to facilitate desired forces in straightening spinal deformities or addressing conditions such as scoliosis.

Strength meters. An example embodiment can comprise a sheet with inductive elements as described herein, configured as strips or grips applied to fixed or moveable equipment. The sensed forces can be used to provide quantitative feedback regarding forces applied by a user, e.g., to monitor strength, to measure timing of response to stimulus, or to assess technique (e.g., by direction, magnitude, and timing of force application). The embodiment can be combined with position sensors to provide force information as related to range of motion or position.

Diaper fit. An example embodiment can comprise a sheet with inductive elements as described herein, configured as strips mounted with a diaper or similar garment to facilitate proper positioning and application by sensing forces in regions important to collection and leakage prevention.

Support stockings. An example embodiment can comprise a sheet with inductive elements as described herein, configured to mount with compression or support stocking. The forces sensed can facilitate proper pressures applied to the limb, e.g., to prevent or head venous stasis leg ulcers. The embodiment can be combined with air bladders responsive to the forces senses to promote fluid flow in the leg, e.g., to promote healing.

Knee and other braces. An example embodiment can comprise a sheet with inductive elements as described herein, configured to mount with braces such as knee or ankle braces. The sensed forces can be used to facilitate selection of a proper brace, adjustment of a brace, monitoring usage and damage to a brace, monitoring continued fitment of a brace. The embodiment can be combined with an expandible or adjustable region of the brace, e.g., a deformable element comprising an inflatable bladder, a shape memory element, or an electrically controlled actuator, and the forces sensed used to control the adjustable region to tailor the forces exerted by the brace on the patient to a desired force profile, e.g., to maintain constant forces as the user moves when walking or playing a sport, e.g., to supply additional reinforcement in selected areas when excessive forces are sensed such as during an impact.

Helmets. An example embodiment can comprise a sheet with-inductive elements as described herein, configured to mounts with a safety helmet, such as used in football, hockey, boxing, and auto racing, e.g., as strips that mount at regions of the helmet corresponding to contact with the user's head. The forces sensed, magnitude, direction, and time-dependence, can be used to monitor user condition, and to determine and quantify the location and severity of impacts and possible resulting concussions. The forces sensed can also be used to assess the performance of the helmet under various use scenarios.

Automobiles. An example embodiment can comprise a sheet with inductive elements as described herein, configured to mount with various systems of an automobile and provide force monitoring specific to that system. E.g., sheets can be mounted with seats to assess forces on the driver, for racing optimization, seat design, and to facilitate safe driving in public road travel. E.g., strips can be mounted with w steering wheel to assess grip forces and applied torque by measuring the forces circumferential forces applied through the strip from the user's grip to the steering wheel. E.g., as strips used as part of or with seat belts to facilitate proper use and to evaluate forces from driving or from accidents. E.g., as part of or overlaid on brake, clutch, or accelerator pedals, to assess performance and driving characteristics. E.g., as strips mounted with head or leg supports, brake components, tires and wheels, windshield wiper contact force, or opening closure contacts (door, trunk, hatch, hood, etc.).

Boxing gloves, punching bag, race suits, hockey pucks, armor, sports uniforms. An example embodiment can comprise a sheet with inductive elements as described herein, configured to mount with sporting or other equipment to assess forces in use, from which speed and direction can be determined. The sheets can be incorporated, as examples, in boxing gloves, punching bags, body armor, uniforms such as hocky goalie shirts or pads, hockey pucks or balls used in other sports, to provide information regarding performance during use; to evaluate changes in design, rules, or technique; and to predict remaining useful life of the equipment.

Performance mats. An example embodiment can comprise a sheet with inductive elements as described herein, configured to form or mount with, on, or under a mat on which a user stands. The embodiment can sense pressures exerted by the user during an activity such as a golf club swing, a baseball bat swing, a baseball throw or catch, a basketball shot or move, a simulated or actual snowboard maneuver, or a simulated or actual surfing maneuver. The magnitude, direction, and timing of forces exerted by the user on the embodiment can be used to assess performance, power, and technique of the user, such as balance, transfer of balance during the motion, etc.

Gloves. An example embodiment can comprise a sheet with inductive elements as described herein, configured to form or mount with a glove or a handle, e.g., a golf glove or a golf club handle, or a batting glove or a bat handle, or a gun or military implement or a corresponding glove. The forces sensed can track grip forces and timing as the swing is performed allowed assessment of forces, performance, speed, and technique.

Equipment interfaces. An example embodiment can comprise a sheet with-inductive elements as described herein, configured to mount with or form part of equipment such as a treadmill surface, a horse saddle, a yoga mat, weightlifting equipment, diving boards, trampolines, gymnastics mats or apparatus. The forces sensed can assess user performance and technique, as well as contact forces to assess equipment design requirements.

Haptic sensing and feedback. An example embodiment can comprise a sheet with inductive elements as described herein, configured to sense forces applied by a user to devices such as joysticks, trackballs, wands, mats, gloves, helmets, etc. The forces sensed can implement computer input function for applications like video games and virtual assistance. The embodiment can be combined with force feedback systems to apply forces to the user reflecting forces determined in the computer system, e.g., forces from a computer game or forces from a remote sensor in a telepresence application. The forces sensed on a mat can also be used as inputs to alter a display, e.g., the forces used to determine changes in user position or balance or posture, and a display adjusted responsive to such changes.

Seats. An example embodiment can comprise a sheet with inductive elements as described herein, configured to form part of or mount with a seat, e.g., an office chair, other furniture, couch, boat seats, airplane seats, train seats, car and truck seats, scooter and motorcycle and bicycle seats, heavy and industrial equipment seats. Forces sensed can be used to assess performance, to monitor condition, and to provide information for custom design of a seat to match individual user characteristics and application needs, and to provide information for real time adjustment of adjustable elements of a seat to facilitate desirable forces in the user/seat interface.

Fine spatial resolutions contact force imaging. An example embodiment can comprise a sheet with-inductive elements as described herein, configured to for strips that are mounted with two surfaces, where the forces sensed provide information concerning the intimacy of contact between the two surfaces.

Airfoil or suction cup (negative pressure) sensors. An example embodiment can comprise a sheet with inductive elements as described herein, configured to mount with or form part of a wing on an aircraft or other high speed vehicle. Negative pressure increased airspeed can be sensed, and used to assess performance, inform design and customization, and to control configuration of the vehicle responsive to actual lift, drag, and impact forces.

Shape sensor. An example embodiment can comprise a sheet with inductive elements as described herein, configured to drape over or otherwise interface with an unknown shapes. The forces—pressure and shear—can be combined with knowledge of the material properties to discover the unknown shape.

Measuring the influence of temperature on seal. An example embodiment can comprise a sheet with inductive elements as described herein, configured as strips that mount with a sealing surface (e.g., a gasket between two surfaces, an O-ring, a washer, or two surfaces that are brought into a sealing relationship by proximity). Mutual inductance of the conductive elements allow determination of the forces at the sealing interface, e.g., to verify proper seal, and to track proper seal through events such as temperature cycles and external stresses.

The present invention has been described in connection with various example embodiments. It will be understood that the above descriptions are merely illustrative of the applications of the principles of the present invention, the scope of which is to be determined by the claims viewed in light of the specification. Other variants and modifications of the invention will be apparent to those skilled in the art.

What is claimed is:

1. A force sensing apparatus comprising:
(a) a sheet have first and second opposing surfaces, comprising a material have a compressibility normal to the surfaces of the sheet and a stretchability parallel to the surfaces of the sheet;
(b) one or more first conductive elements mounted with the first surface of the sheet;
(c) one or more second conductive elements mounted with the second surface of the sheet, where the first and second conductive elements are configured such that current does not directly flow between them, and such that an alternating signal supplied to a first conductive element inductively couples to a second conductive element and produces a responsive alternating signal.

2. The apparatus of claim 1, wherein the first conductive elements comprise an electrical conductor disposed in a first loop parallel to the first surface, and the second conductive elements comprise an electrical conductor disposed in a second loop parallel to the second surface, wherein each second conductive element is disposed such that the area of the second loop of the second conductive element overlaps the area of the first loop of a corresponding first conductive element.

3. The apparatus of claim 2, wherein the first loop has a circular shape.

4. The apparatus of claim 3, wherein the second loop has a circular shape.

5. The apparatus of claim 1, further comprising a signal generator configured to supply an excitation signal to the first conductive elements.

6. The apparatus of claim 5, wherein the excitation signal is a time varying signal, with a lowest frequency component above 10Hz.

7. The apparatus of claim 6, wherein the excitation signal is a time varying signal, with a lowest frequency component between 100 Hz and 20 KHz.

8. The apparatus of claim 7, wherein the excitation signal is a time varying signal, with a lowest frequency component between 1 kHz and 10 kHz.

9. The apparatus of claim 5, wherein the excitation signal has a voltage that varies from peak to trough by greater than 0.1V.

10. The apparatus of claim 9, wherein the excitation signal has a voltage that varies from peak to trough by 4V to 6V.

11. The apparatus of claim 5, wherein the excitation signal is sinusoidal.

12. The apparatus of claim 5, further comprising a detector configured to detect the responsive alternating signal from the second conductive elements.

13. The apparatus of claim 12, further comprising an analysis system configured to compare the amplitude of the responsive alternative signal to the excitation signal and determine a force acting on the sheet from the magnitude comparison.

14. The apparatus of claim 12, further comprising an analysis system configured to compare the phase of the responsive alternative signal to the excitation signal and determine a force acting on the sheet from the phase comparison.

15. The apparatus of claim 12, wherein the analysis system is further configured to compare the phase of the responsive alternative signal to the excitation signal and determine a force acting on the sheet from the phase comparison, and to determine a component of force normal to the first surface of sheet from the magnitude comparison, and to determine a component of force parallel to the first surface of the sheet from the phase comparison.

16. The apparatus of claim 1, wherein the sheet comprises a fabric, and wherein the first conductive elements comprise a conductive thread sewn into sheet.

17. A method of determining force acting on a sheet, comprising supplying an apparatus as in claim 1, supplying an excitation signal to the first conductive elements, sensing the responsive signal from the second conductive elements, comparing the magnitudes of the excitation signal and the responsive signal, comparing the phases of the excitation signal and the responsive signal, and determining the forces from the comparisons of magnitude and phase.
